(19) United States
(12) Patent Application Publication
(10) Pub. No.: US 2020/0302455 A1
(43) Pub. Date: Sep. 24, 2020

(54) Industry Forecast Point of View Using Predictive Analytics

(71) Applicant: Dell Products L.P., Round Rock, TX (US)

(72) Inventors: Laura Arroyo, Round Rock, TX (US); Richard Bigega, Round Rock, TX (US); Abhishek Syal, Somerville, MA (US)

(73) Assignee: Dell Products L.P., Round Rock, TX (US)

(21) Appl. No.: 16/361,398

(22) Filed: Mar. 22, 2019

(51) Int. Cl. G06Q 30/02; G06N 20/00

(52) U.S. Cl. CPC G06Q 30/0202; G06N 20/00

(57) ABSTRACT

A system, method, and computer-readable medium are disclosed for using machine learning to improve forecasting of market behavior which includes identifying market forecast data associated with forecasting intervals; retrieving the forecast data and actual market behavior data corresponding to a historical forecasting interval; generating a historical market behavior forecast by performing a forecasting operation using the market forecast data and a machine learning forecasting model; identifying a particular machine learning model corresponding to a target forecasting interval based upon results of the historical market behavior forecast for corresponding historical forecasting intervals; and, generating a market behavior forecast for each interval using the particular machine learning operation.

### BACKGROUND OF THE INVENTION

### Field of the Invention

The present invention relates to information handling systems. More specifically, embodiments of the invention relate to using machine learning to improve forecasting of market behavior.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium are disclosed for using machine learning to improve forecasting of market behavior.

More specifically, in one embodiment the invention relates to a computer-implementable method for forecasting market behavior, comprising: identifying market forecast data associated with forecasting intervals; retrieving the forecast data and actual market behavior data corresponding to a historical forecasting interval; generating a historical market behavior forecast by performing a forecasting operation using the market forecast data and a machine learning forecasting model; identifying a particular machine learning model corresponding to a target forecasting interval based upon results of the historical market behavior forecast for corresponding historical forecasting intervals; and, generating a market behavior forecast for each interval using the particular machine learning operation.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: identifying market forecast data associated with forecasting intervals; retrieving the forecast data and actual market behavior data corresponding to a historical forecasting interval; generating a historical market behavior forecast by performing a forecasting operation using the market forecast data and a machine learning forecasting model; identifying a particular machine learning model corresponding to a target forecasting interval based upon results of the historical market behavior forecast for corresponding historical forecasting intervals; and, generating a market behavior forecast for each interval using the particular machine learning operation.

In another embodiment the invention relates to a computer-readable storage medium embodying computer program code, the computer program code comprising computer executable instructions configured for: identifying market forecast data associated with forecasting intervals; retrieving the forecast data and actual market behavior data corresponding to a historical forecasting interval; generating a historical market behavior forecast by performing a forecasting operation using the market forecast data and a machine learning forecasting model; identifying a particular machine learning model corresponding to a target forecasting interval based upon results of the historical market behavior forecast for corresponding historical forecasting intervals; and, generating a market behavior forecast for each interval using the particular machine learning operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a customer service interaction estimation environment.

FIG. 3 shows a simplified block diagraph depicting the relationship of market forecasting seasons and market forecasting intervals;

FIG. 4 shows a simplified block diagram of a market forecast system implemented to generate a market behavior forecast for a target forecasting season;

FIG. 5 is a process diagram showing the operation of a market forecast system implemented to generate a market behavior forecast for a target forecasting season;

FIG. 6 depicts the selection of certain forecasting algorithms implemented to respectively generate the most accurate market behavior forecast for a plurality of target forecasting seasons; and

FIGS. 7a through 7c show a flowchart of market behavior forecasting operations.

### DETAILED DESCRIPTION

A system, method, and computer-readable medium are disclosed for using machine learning to improve forecasting of market behavior. Certain aspects of the invention reflect an appreciation that is common for many organizations to employ various forecasting approaches in an attempt to cope with the uncertainty of the future. Certain aspects of the invention likewise reflect an appreciation that such approaches typically rely upon analysis of not just current and historical data, but observed trends as well. Likewise, various aspects of the invention reflect an appreciation that while certain forecasting approaches may inherently be based upon qualitative experience, knowledge and judgment, their accuracy typically involves some degree of quantitative, statistical, and predictive analysis.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

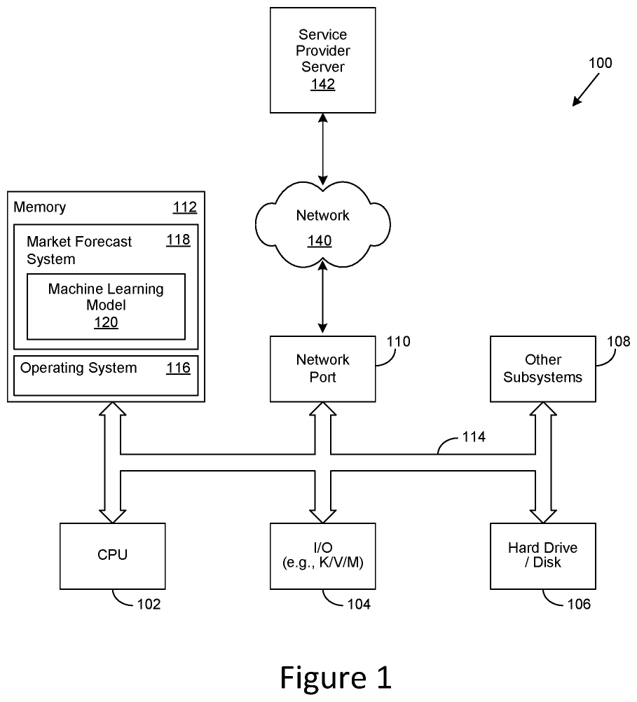

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a market forecast system 118. In certain embodiments, the market forecast system 118 may be implemented to include a machine learning model 120. In one embodiment, the information handling system 100 is able to download the market forecast system 118 from the service provider server 142. In another embodiment, the market forecast system 118is provided as a service from the service provider server 142.

The market forecast system 118 performs a market behavior forecasting operation. The market forecast system 118 operation improves processor efficiency, and thus the efficiency of the information handling system 100, facilitating the forecasting of a market's behavior. In certain embodiments, the market behavior forecasting operation can be performed during operation of an information handling system 100. As will be appreciated, once the information handling system 100 is configured to perform the market behavior forecasting operation, the information handling system 100 becomes a specialized computing device specifically configured to perform the market behavior forecasting operation and is not a general purpose computing device. Moreover, the implementation of the market behavior forecasting operation on the information handling system 100 improves the functionality of the information handling system 100 and provides a useful and concrete result of forecasting the behavior of a market. In certain embodiments, the performance of the market behavior forecasting operation results in the realization of a more accurate market forecast.

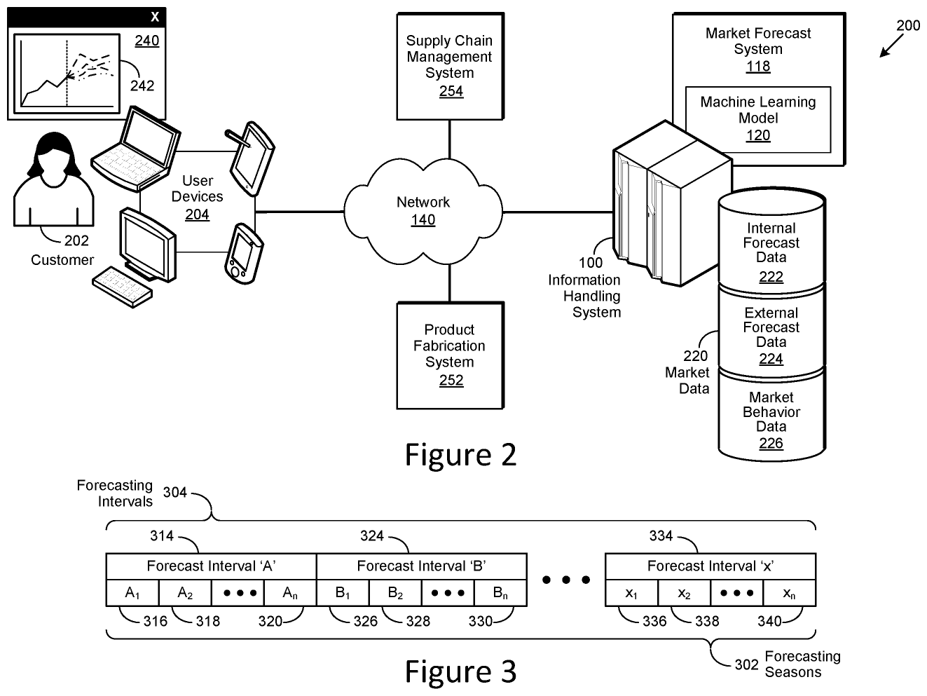

FIG. 2 is a block diagram of a market forecast environment 200 implemented in accordance with an embodiment of the invention. In certain embodiments, the market forecast environment 200 may include a market forecast system 118. In certain embodiments, the market forecast environment 200 may include a repository of market data 220. In certain embodiments, the repository of market data 220 may be local to the system executing the market forecast system 118 or may be executed remotely. In various embodiments, the repository of market data 220 may include certain information associated with internal forecast data 222, external forecast data 224, and market behavior data 226.

In certain embodiments, the market forecast system 118 may include a machine learning model 120. In various embodiments, the market forecast system 118 may be implemented to perform certain market behavior forecasting operations, described in greater detail herein. In various embodiments, the machine learning model 120 may be implemented to perform certain machine learning operations associated with generating a market behavior forecast.

In certain embodiments, a user 202 may use a user device 204 to interact with the market forecast system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a market forecast system user interface (UI) 240. In certain embodiments, the market forecast system UI 240 may be implemented to present a graphical representation 242 of market behavior forecast information, which is automatically generated in response to interaction with the market forecast system 118.

In certain embodiments, the user device 204 is used to exchange information between the user 202 and the market forecast system 118, a product fabrication system 252 and a supply chain management system 254 through the use of a network 140. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In certain embodiments, the market forecast system UI 240 may be presented via a website. For the purposes of this disclosure a website may be defined as a collection of related web pages which are identified with a common domain name and is published on at least one web server. A website may be accessible via a public IP network or a private local network.

A web page is a document that is accessible via a browser, which displays the web page via a display device of an information handling system. In certain embodiments, the web page also includes the file which causes the document to be presented via the browser. In certain embodiments, the web page may comprise a static web page, which is delivered exactly as stored, and a dynamic web page, which is generated by a web application that is driven by software that enhances the web page via user input to a web server.

In certain embodiments, the market forecast system 118 may be implemented to interact with the product fabrication system 252, which in turn may be executing on a separate information handling system 100. In various embodiments, the product fabrication system 252 interacts with a supply chain management system 254. In certain embodiments, the product fabrication system 252 fabricates products, which may result in the need to have accurate market behavior forecasts for the products it may fabricate. In certain embodiments, the market forecast system 118 may be implemented to perform a market behavior forecast function, as described in greater detail herein, which facilitates the operation of the supply chain management system 254. In certain embodiments, the facilitation of the operation of the supply chain management system 254 may result in more efficient and cost-effective operation of the product fabrication system 252.

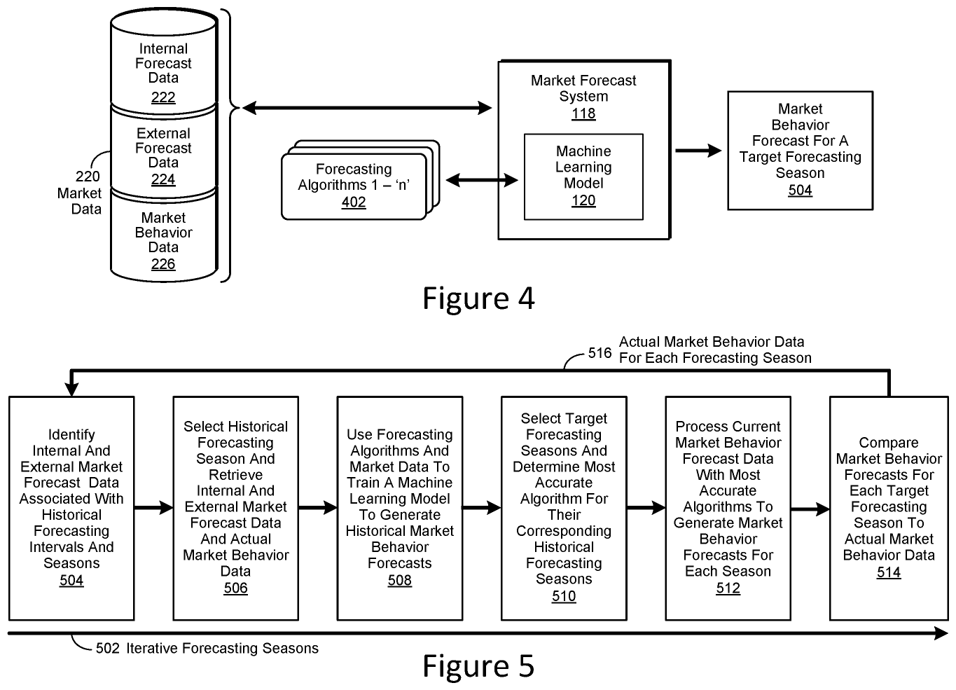

FIG. 3 shows a simplified bock diagram depicting the relationship of market forecasting seasons and market forecasting intervals, as implemented in accordance with an embodiment of the invention. In certain embodiments, the market forecast system 118 shown in FIGS. 1 and 2 may be implemented to perform a market behavior forecasting operation. As used herein, a market broadly refers to various systems, institutions, procedures, social relations, and infrastructures where forces of supply and demand operate. In general, markets are where buyers and sellers interact, directly or through intermediaries, to trade goods, services, and contracts or other instruments, for money or barter. Markets also provide various mechanisms for determining the price of an item, communicating its price information, facilitating a transaction associated with the item, and effecting its distribution. In practice, the market for a particular item is made up of existing and potential buyers who need it and have the ability and willingness to pay for it.

As likewise used herein, market behavior broadly refers to selling and buying trends exhibited by organizations, businesses, and individual consumers within a particular market or market segment. Certain embodiments of the invention reflect an appreciation that analysis of such behavioral trends is often used to devise various strategies intended to boost sales. Forecasting, as likewise used herein, broadly refers to the process of making predictions of the future based upon past and present data, and commonly, by analysis of certain trends. Likewise, as it relates to market behavior, forecasting broadly refers to various approaches that use historical data as inputs to make informed estimates that are predictive in the determining the direction of future market trends.

Certain embodiments of the invention reflect an appreciation that market trends may indicate demand, or lack thereof, for various goods and services. Certain embodiments of the invention likewise reflect an appreciation that organizations often utilize market behavior forecasting to project demand for the goods and services they offer and allocate their budgets, resources, and production accordingly. Likewise, certain embodiments of the invention reflect an appreciation that organizations may benefit from more accurate forecasts of supply and demand dynamics of various raw material components, labor market trends, industry performance measures, and other indicators of operational and financial health.

In certain embodiments, the market behavior forecasting operation may be related to forecasting the behavior of a certain market, or market segment, for a particular forecasting season 302 and its associated forecasting interval 304. As used herein, a forecasting season 302 broadly refers to a characteristic of a time series, in which observed data exhibits behavior that recurs within an associated forecasting interval 302 in a periodic, regular, repetitive and predictable pattern. Said somewhat differently, any predictable change or pattern in a time series that typically recurs or repeats within a forecasting interval 304 can be characterized as being seasonal.

As likewise used herein, a forecasting interval 304 broadly refers to a recurring series of time intervals that include two or more corresponding forecasting seasons 302. For example, as shown in FIG. 3, forecasting intervals 304 ‘A’ 314, ‘B’ 324 and ‘x’ 334, respectively have corresponding forecasting seasons 302 ‘A₁’ 316, ‘A₂’ 318 through ‘Aₙ’ 320, ‘B₁’ 326, ‘B₂’ 328 through ‘B_{nb}’ 330, and ‘x₁’ 336, ‘x₂’ 338 through ‘xₙ’ 340. To further illustrate the example, forecasting intervals 304 ‘A’ 314, ‘B’ 324 and ‘x’ 334 may respectively correspond to calendar years 2016, 2017 and 2020, each of which includes quarterly seasons Q1, Q, Q3 and Q4, which respectively correspond to one another.

In certain embodiments, the time units used to measure a forecasting interval; 304 or a forecasting season 302 may include calendar quarters, months, weeks, days, hours, or minutes. In certain embodiments, the forecasting intervals 304 may be contiguous, such as calendar years 2016, 2017, 2018, and so forth. In certain embodiments, the forecasting seasons 302 may likewise be contiguous, such as calendar months January, February, March, and so forth. In certain embodiments, the forecasting intervals 304, or forecasting seasons 302, or a combination thereof, may not be contiguous.

Certain embodiments of the invention reflect an appreciation that it is often advantageous for various organizations to identify and measure seasonal variations within their market to help them plan for the future. Various embodiments of the invention likewise reflect an appreciation that such planning may allow an organization to prepare for temporary increases or decreases in labor requirements and inventory as demand for their product or service fluctuates over certain periods. Likewise, certain embodiments of the invention reflect an appreciation that seasonality may be caused by various factors, such as market forces, the health, or lack thereof, of financial markets, geopolitical dynamics, such as increases or decreases in Gross Domestic Product (GDP), advances in technology and so forth.

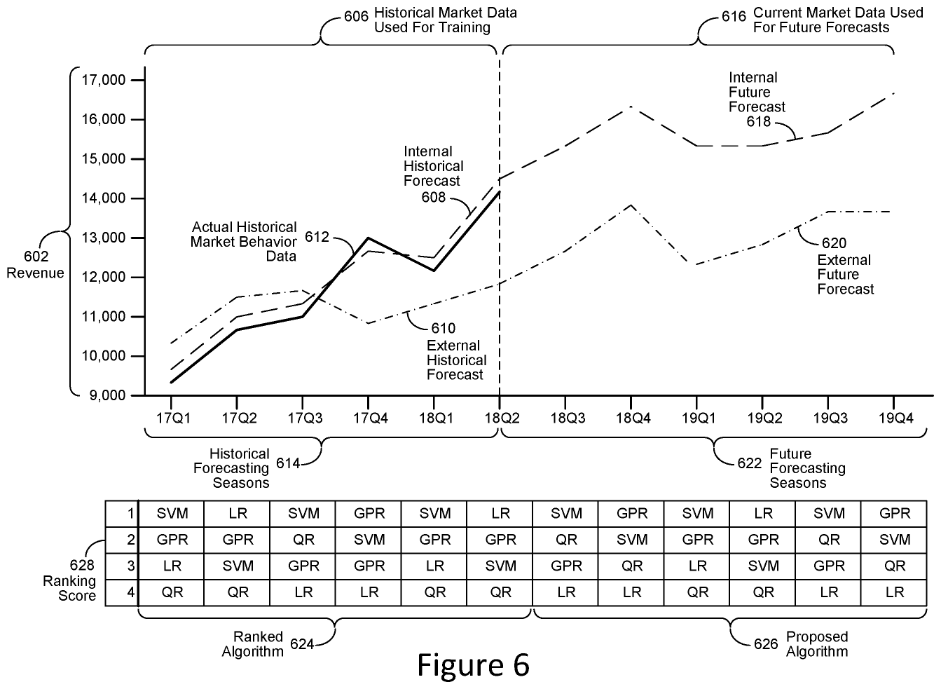

FIG. 4 shows a simplified block diagram of a market forecast system implemented in accordance with an embodiment of the invention to generate a market behavior forecast for a target forecasting season. In various embodiments, certain market data is processed by a market forecast system 118 may be implemented to use certain market data 220 to perform various market behavior forecasting operations, described in greater detail herein, to generate a market behavior forecast 504 for a target forecasting season. In certain embodiments, the market data 220 may include internal forecast data 222, external forecast data 222, and market behavior data, or a combination thereof.

In various embodiments, the market forecast system 118 may be implemented with an associated machine learning model 120 to perform certain market behavior forecasting operations. In various embodiments, certain forecasting algorithms 1−-‘n’ may be used to train the machine learning model 120. In certain embodiments, the use of forecasting algorithms 1-1 ‘n’ to train the machine learning model may result in the generation of more accurate market behavior forecasts 504 for a target forecasting season. In certain embodiments, the forecasting algorithms 1-‘n’ may include linear regression (LR), quadratic regression (QR), Gaussian process regression (GPR), support vector machine (SVM), and others.

Skilled practitioners of the art will be familiar with various linear regression approaches to modeling the relationship between a scalar response, or dependent variable, and one or more explanatory, or independent variables. In typical implementation, the use of a single explanatory variable is referred to as a simple linear regression process, while the use of two or more explanatory variables is referred to as a multiple linear regression process. Those of skill in the art will likewise be aware that a multiple linear regression process is distinct from multivariate linear regression, where multiple correlated dependent variables are predicted, rather than a single scalar variable. In linear regression, relationships are modeled using linear prediction functions whose unknown model parameters are estimated from certain input data. Such models are known as linear models.

Skilled practitioners of the art will likewise recognize that linear regression approaches can be useful in the generation of market behavior forecasts, as they are often implemented to fit a predictive model to an observed dataset of values corresponding to response and explanatory variables. Once such a model is developed, additional values of the explanatory variables can be collected without an accompanying response value and the fitted model can be used to make a prediction of the response. Accordingly, linear regression approaches often prove useful when attempting to reduce prediction errors in market behavior forecasts.

Those of skill in the art will likewise be familiar with quadratic regression (QR), an extension of simple linear regression, that is a process for finding the equation of a parabola that best fits a set of data. Likewise, skilled practitioners of the art will be aware that linear regression can be performed with as few as two points, which provide enough points to draw a straight line, quadratic regression requires more data points. More specifically, quadratic regression requires a sufficient number of data points to fall within a “U” shape. While quadratic regression can technically be performed with three data points that fit a “V” shape, more points are desirable. Accordingly, since more data points are required, quadratic regression approaches are more computationally expensive than simple linear regression.

Likewise, those of skill in the art will likewise be familiar with Gaussian process regression (GPR), which is a method of interpolating values modeled by a Gaussian process governed by prior covariances. When suitable assumptions are used or the prior covariances, GPR approaches are known to provide best linear unbiased prediction of intermediate values. As typically implemented, GPR is able to predict the value of a function at a given point by computing a weighted average of the known values of the function in the neighborhood of the point. Accordingly, GPR is closely related to regression analysis. However, GPR is better suited for estimation of a single realization of a random field, while regression models are based on multiple observations of a multivariate dataset.

Skilled practitioners of the art will likewise be familiar with support vector machine (SVM), which refer to various supervised learning models with associated learning algorithms that analyze data used for classification and regression analysis. In typical implementation, an SVM training algorithm builds a model that assigns new examples to one category or another, based upon a set of training examples. Accordingly, SVM operates as a non-probabilistic binary linear classifier, providing a representation of examples as points in space, such that examples of categories are divided by a clear gap that is as wide as possible. New examples are then mapped in the same space and predicted to belong to a category based upon which side of the gap they may fall. Skilled practitioners of the art will likewise be familiar with other forecasting algorithms suitable for use in training a machine learning model 120. Accordingly, the actual forecasting algorithms 1-‘n’ used in certain embodiments to train the machine learning model 120 is a matter of design choice.

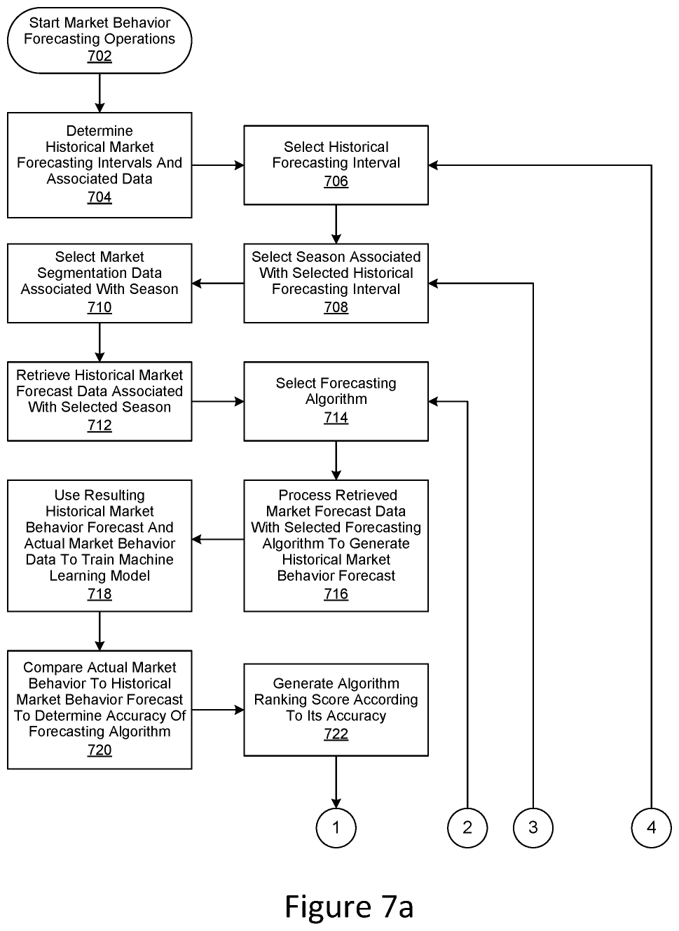

FIG. 5 is a process diagram showing the operation of a market forecast system implemented in accordance with an embodiment of the invention to generate a market behavior forecast for a target forecast season. In various embodiments, market behavior forecasts may be generated for certain iterative forecasting seasons 502. In these embodiments, the method by which a particular forecasting season may be selected, and which market behavior forecast may be generated, is a matter of design choice.

In certain embodiments, market behavior forecast operations are begun by first determining which historical forecasting intervals, and their associated market data, will be used to train a market forecast system, as described in greater detail herein. As an example, a determination may be made to select four historical forecasting intervals, corresponding to calendar years 2014 through 2017. Likewise, economic indicator information associated with the European Union (EU) and its member countries, such as their respective Gross Domestic Product (GDP), along with data related to certain products associated with one or more manufacturers may be selected. Once the historical forecasting intervals and other associated market data has been selected, a historical forecasting interval, such as the year 2014, is selected. Thereafter, a historical forecasting season associated with the selected historical forecasting interval is likewise selected. To continue the previous example, the first operating quarter (Q1) of the year 2014 may be selected. In various embodiments, certain market segmentation data associated with the previously-selected historical forecasting season may also be selected. In further continuance of the previous example, purchases of enterprise-grade computer servers in the country of France, which is a member of the EU, may be selected as the market segmentation data.

Historical market behavior forecast data associated with the previously-selected forecasting season is then retrieved in step 506. In certain embodiments, the historical market behavior forecast data may be produced internally by an organization, acquired from an external source, or a combination thereof. As an example, internally-produced market behavior forecast data may be produced and provided by various departments within an organization, such as marketing, supply chain management, production, and so forth. Likewise, externally-produced historical market behavior forecast data may be produced and provided by a market analyst, an industry trade group, a government agency, and so forth.

One or more forecasting algorithms, described in greater detail herein, is then used in step 508 to process the previously-retrieved market forecast data to generate a historical market behavior forecast. As used herein, a historical market behavior forecast refers to a market behavior forecast that is generated by using historical market data that was only available prior to the selected historical forecast season. The resulting historical market behavior forecast, along with actual market behavior data associated the previously-selected historical forecast season, is then used to train a machine learning model implemented with an associated market forecast system.

The actual historical market behavior data is then compared to the historical market behavior forecast to determine the accuracy of the forecasting algorithm used to produce it. Once its accuracy has been determined, the preciously-selected forecasting algorithm is assigned an algorithm ranking score. In certain embodiments, the more accurate a particular forecasting algorithm is for a particular historical forecasting season, the higher its algorithm ranking score. In these embodiments, the method of determining the algorithm ranking score is a matter of design choice.

The previously-selected forecasting algorithm, and its assigned algorithm ranking score, is then associated with the previously-selected historical forecasting season. The process is then repeated to produce an algorithm ranking score for each forecasting algorithm used to generate a historical market behavior forecast for the previously-selected historical forecasting season. In certain embodiments, the resulting historical market behavior forecasts may likewise be used in step 508 to train a machine learning model implemented with the market forecast system.

Target forecasting seasons are then selected in step 510, followed by determining the highest-ranked forecasting algorithm associated with their respective historical forecasting season at step 512. As an example, if the target forecasting season is Q1 of the year 2020, then the highest-ranked and most accurate forecasting algorithm for the historical forecasting season corresponding to Q1 of the year 2014 may be selected. Current market behavior forecast data is then respectively processed with the selected forecasting algorithm to generate a market behavior forecast for each target forecasting season. The resulting market behavior forecasts each target forecasting season are then compared to actual market behavior data in step 514. The actual market behavior data for each target forecasting season is then retained in step 516 for future use in training a machine learning model implemented with a market forecast system. The process is then repeated for iterative forecasting seasons 502.

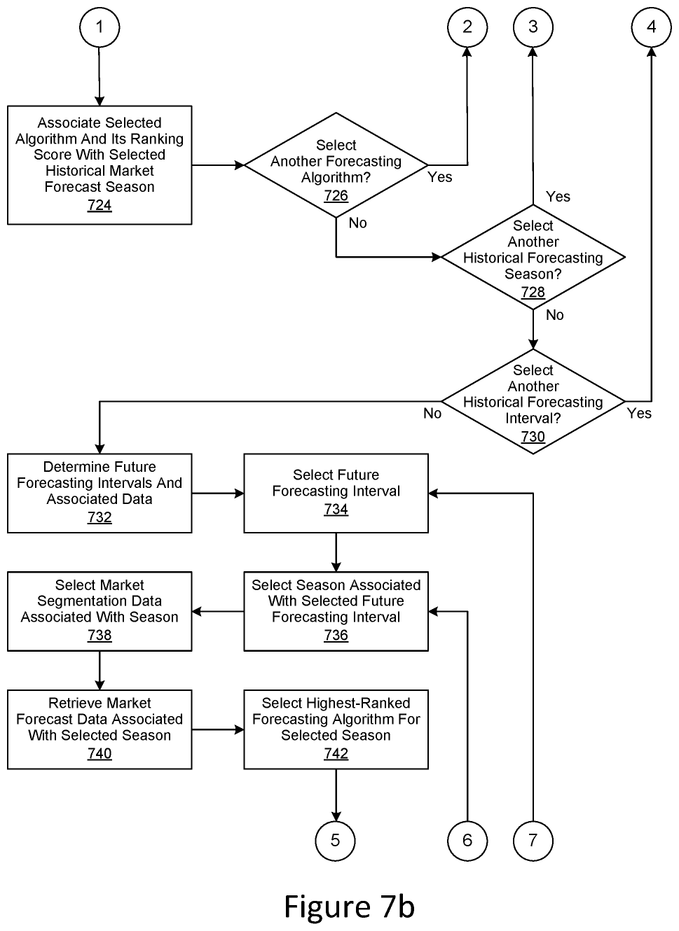

FIG. 6 depicts the selection of certain forecasting algorithms implemented in accordance with an embodiment of the invention to respectively generate the most accurate market behavior forecast for a plurality of target forecast seasons. In various embodiments, as described in greater detail herein, certain historical market data 606 respectively corresponding to one or more historical forecasting seasons 614 may be used to train a machine learning module implemented with a market forecast system. In certain embodiments, as likewise described in greater detail herein, the historical market data 606 may include internally-produced 608 historical market behavior forecasts, externally-produced 610 historical market behavior forecasts, and actual market behavior data 612, or a combination thereof. In certain embodiments, the historical market data 606 may be referenced in terms of revenue 602. In certain embodiments, the historical market data 602 may be expressed in other terms, such as number of units.

In certain embodiments, as described in greater detail herein, two or more forecasting algorithms may be used to generate an internally-produced 608 historical market behavior forecast for a particular historical forecasting season 614. In certain embodiments, the resulting internally-produced 608 historical market behavior forecasts may then be compared to the actual historical market behavior data 612 corresponding to their associated historical forecasting season 614 to determine which of the forecasting algorithms was most accurate. In certain embodiments, the degree of accuracy may be determined by a correlation coefficient value, expressed as ‘R²’, between each internally-produced 608 historical market behavior forecast and the actual historical market behavior 612 for their associated historical forecasting season 614.

In certain embodiments, the accuracy of a particular forecasting algorithm may be expressed as R², which results in a statistical value of ‘1.0’ for a completely accurate correlation. Accordingly, the R² value corresponding to each forecasting algorithm for an associated historical forecasting season 614 may be implemented in certain embodiments as an algorithm ranking score 628. In certain embodiments, the algorithm ranking score 628 may be implemented as the actual value of R² for the forecasting algorithm.

In certain embodiments, the R² value corresponding to each forecasting algorithm may be implemented to rank the algorithms in descending numeric order. As an example, four forecasting algorithms may respectively have an associated R² value of ‘0.9’, ‘0.8’, ‘0.6’, and ‘0.4’, which may respectively result in a corresponding forecasting algorithm ranking score of ‘1’, ‘2’, ‘3’, and ‘4’. In certain embodiments, the frequency in which a particular forecasting algorithm produces the most accurate results in previous forecasts may be used as a factor when determining its associated algorithm ranking score 628. In certain embodiments, the resulting forecasting algorithm ranking scores may be implemented for ranking forecasting algorithms 624 for each historical forecasting season 614.

In certain embodiments, the accuracy of a particular forecasting algorithm may be determined through a root-mean-square error (RMSE) calculation, which is frequently used to measure the differences between sample or population values predicted by a model. As those of skill in the art will be aware that RMSE represents the square root of the second sample moment of the difference between predicted values and observed values or the quadratic mean of these differences. Such deviations are known as residuals when the calculations are performed over the data sample used for estimation and referred to as errors when computed out-of-sample.

As skilled practitioners are also aware, RMSE serves to aggregate the magnitudes of errors in predictions for various points in time into a single measure of predictive power. Accordingly, RMSE is a measure of accuracy that is useful when comparing forecasting errors of different models for a particular data set, such as historical market data 606. In certain embodiments, the RMSE value corresponding to a particular forecasting algorithm used to generate an internally-produced 608 historical market behavior forecast may be used as its forecasting algorithm ranking score 628. As described in greater detail herein, the RMSE value corresponding to two or more forecasting algorithms may be assigned a numeric ranking score 628, which results in ranked forecasting algorithms 624 for each historical forecasting seasons 614.

In various embodiments, as described in greater detail herein, certain current market data 616 respectively corresponding to one or more future forecasting seasons 622 may be used to generate associated internally-produced 618 future market behavior forecasts. In certain embodiments, a proposed forecasting algorithm 626 for each future forecasting season 622 may be used for processing the current market data 616 to generate a corresponding internally-produced future market behavior forecast 618. In certain embodiments, the forecasting algorithm 626 proposed for generating an internally-produced future market behavior forecast 618 for a particular future forecasting season 622 may be based upon its associated forecasting algorithm ranking score 628.

In certain embodiments, the proposed forecasting algorithm 626 for a particular future forecasting season 622 is the same as the highest-ranked forecasting algorithm for a corresponding historical forecasting season 618 associated with a previous forecasting interval. For example, as shown in FIG. 6, the highest-ranked forecasting algorithm 604 for the first quarter of 2017 (17Q1) is support vector machine (SVM). Accordingly, SVM is the proposed forecasting algorithm 626 for use in generating an internally-produced future market behavior forecast 618 corresponding to the first quarter of 2019 (19Q1). In certain embodiments, internally-produced 618 and externally-produced 620 future market behavior forecasts may be retained for future use in training a machine learning model implemented with a market forecast system.

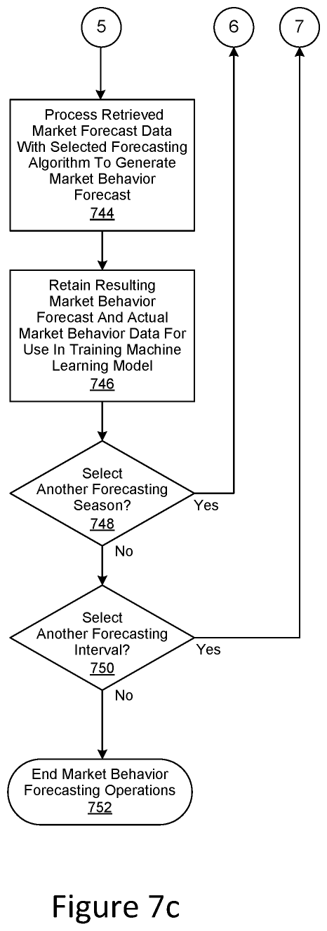

FIGS. 7a through 7c show a flowchart of market behavior forecasting operations implemented in accordance with an embodiment of the invention. In this embodiment, market behavior forecast operations are begun in step 702, followed by determining in step 704 which historical forecasting intervals, and other associated market data, will be used to train a market forecast system, described in greater detail herein. Once the historical forecasting intervals and other associated market data has been selected in step 704, a historical forecasting interval is selected in step 706, followed by the selection of an associated historical forecasting season in step 708. Market segmentation data associated with the previously-selected historical forecasting season is then selected in step 710.

Historical market behavior forecast data associated with the previously-selected forecasting season is then retrieved in step 712. A forecasting algorithm, described in greater detail herein, is then selected in step 714 and used in step 716 to process the previously-retrieved market forecast data to generate a historical market behavior forecast. The resulting historical market behavior forecast, along with actual market behavior data associated the previously-selected historical forecast season, is then used in step 718 to train a machine learning model implemented with an associated market forecast system.

The actual historical market behavior data is then compared in step 720 to the historical market behavior forecast to determine the accuracy of the forecasting algorithm used to produce it. Once its accuracy has been determined, the preciously-selected forecasting algorithm is assigned an algorithm ranking score in step 722. The previously-selected forecasting algorithm, and its assigned algorithm score, is then associated with the previously-selected historical forecasting season in step 724. A determination is then made in step 726 whether to select another forecasting algorithm to generate another historical market behavior forecast. If so the process is continued, proceeding with step 714.

In certain embodiments, the determination of which forecasting algorithm to select, and how many forecasting algorithms to use in the generation of historical market behavior forecasts, is a matter of design choice. However, if it is determined in step 726 not to select another forecasting algorithm, then a determination is made in step 728 whether to select another historical forecasting season. If so, then the process is continued, proceeding with step 708. Otherwise, a determination is made in step 730 to select another historical forecasting interval. If so, then the process is continued, proceeding with step 706.

However, if it was determined in step 730 not to select another historical forecasting interval, then market behavior forecasting operations are begun in step 732 by determining future forecasting intervals and their associated market forecast behavior data. Once the future forecasting intervals and other associated market data has been selected in step 732, a future forecasting interval, such as the year 2020, is selected in step 734. Thereafter, a future forecasting season associated with the selected future forecasting interval is selected in step 736. As an example, the first operating quarter (Q1) of the year 2020 may be selected. Market segmentation data associated with the previously-selected future forecasting season is then selected in step 738.

Market behavior forecast data associated with the previously-selected forecasting season is then retrieved in step 740. The highest-ranked forecasting algorithm associated with a historical forecasting season corresponding to the previously-selected forecasting season is then selected in step 742. The retrieved market behavior forecast data is then processed in step 744 with the selected forecasting algorithm to generate a market behavior forecast for the previously-selected forecasting season. The resulting market behavior forecast, and actual market behavior data, associated with the previously-selected forecasting season is then retained in step 746 for future use in training a machine learning model associated with a market forecast system.

A determination is then made in step 748 whether to select another forecasting season. If so, then the process is continued, proceeding with step 736. If not, then a determination is made in step 750 whether to select another forecasting interval. If so, then the process is continued, proceeding with step 734. If not, then market behavior forecasting operations are ended in step 752.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for forecasting market behavior, comprising:
identifying market forecast data associated with forecasting intervals;
retrieving the forecast data and actual market behavior data corresponding to a historical forecasting interval;
generating a historical market behavior forecast by performing a forecasting operation using the market forecast data and a machine learning forecasting model;
identifying a particular machine learning model corresponding to a target forecasting interval based upon results of the historical market behavior forecast for corresponding historical forecasting intervals; and,
generating a market behavior forecast for each interval using the particular machine learning operation.

2. The method of claim 1, further comprising:
comparing the market behavior forecast for a target forecasting interval to actual market behavior data for the target forecasting interval; and,
training a machine learning model based upon the comparing.

3. The method of claim 1, wherein:
the market forecast data comprises internal market forecast data and external market forecast data.

4. The method of claim 1, further comprising:
generating a plurality of historical market behavior forecasts by performing respective forecasting operations using the market forecast data and a plurality of respective forecasting models;
determining which of the plurality of respective forecasting models provides a best forecasting result; and,
the identifying the particular machine learning model comprises using the forecasting model providing the best forecasting result.

5. The method of claim 4, further comprising:
ranking the plurality of respective forecasting models based upon a forecasting result for each of the plurality of respective forecasting models; and,
the determining which of the plurality of respective models provides the best forecasting result is based upon the ranking of the plurality of respective forecasting models.

6. The method of claim 1, wherein:
the forecasting intervals comprise respective forecasting seasons, the target forecasting interval comprise target forecasting seasons, the historical forecasting intervals comprise respective historical forecasting seasons; and,
a market behavior forecast is generated for each season using the particular machine learning operation.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
identifying market forecast data associated with forecasting intervals;
retrieving the forecast data and actual market behavior data corresponding to a historical forecasting interval;
generating a historical market behavior forecast by performing a forecasting operation using the market forecast data and a machine learning forecasting model;
identifying a particular machine learning model corresponding to a target forecasting interval based upon results of the historical market behavior forecast for corresponding historical forecasting intervals; and,
generating a market behavior forecast for each interval using the particular machine learning operation.

8. The system of claim 7, wherein the instructions executable by the processor are further configured for:
comparing the market behavior forecast for a target forecasting interval to actual market behavior data for the target forecasting interval; and,
training a machine learning model based upon the comparing.

9. The system of claim 7, wherein:
the market forecast data comprises internal market forecast data and external market forecast data.

10. The system of claim 7, wherein the instructions executable by the processor are further configured for:
generating a plurality of historical market behavior forecasts by performing respective forecasting operations using the market forecast data and a plurality of respective forecasting models;
determining which of the plurality of respective forecasting models provides a best forecasting result; and,
the identifying the particular machine learning model comprises using the forecasting model providing the best forecasting result.

11. The system of claim 10, wherein the instructions executable by the processor are further configured for:
ranking the plurality of respective forecasting models based upon a forecasting result for each of the plurality of respective forecasting models; and,
the determining which of the plurality of respective models provides the best forecasting result is based upon the ranking of the plurality of respective forecasting models.

12. The system of claim 7, wherein:
the forecasting intervals comprise respective forecasting seasons, the target forecasting interval comprise target forecasting seasons, the historical forecasting intervals comprise respective historical forecasting seasons; and,
a market behavior forecast is generated for each season using the particular machine learning operation.

13. A non-transitory, computer-readable storage medium embodying computer program code, the computer program code comprising computer executable instructions configured for:
identifying market forecast data associated with forecasting intervals;
retrieving the forecast data and actual market behavior data corresponding to a historical forecasting interval;
generating a historical market behavior forecast by performing a forecasting operation using the market forecast data and a machine learning forecasting model;
identifying a particular machine learning model corresponding to a target forecasting interval based upon results of the historical market behavior forecast for corresponding historical forecasting intervals; and,
generating a market behavior forecast for each interval using the particular machine learning operation.

14. The non-transitory, computer-readable storage medium of claim 13, wherein the computer executable instructions are further configured for:
comparing the market behavior forecast for a target forecasting interval to actual market behavior data for the target forecasting interval; and,
training a machine learning model based upon the comparing.

15. The non-transitory, computer-readable storage medium of claim 14, wherein:
the market forecast data comprises internal market forecast data and external market forecast data.

16. The non-transitory, computer-readable storage medium of claim 13, wherein the computer executable instructions are further configured for:
generating a plurality of historical market behavior forecasts by performing respective forecasting operations using the market forecast data and a plurality of respective forecasting models;
determining which of the plurality of respective forecasting models provides a best forecasting result; and,
the identifying the particular machine learning model comprises using the forecasting model providing the best forecasting result.

17. The non-transitory, computer-readable storage medium of claim 16, wherein the computer executable instructions are further configured for:
ranking the plurality of respective forecasting models based upon a forecasting result for each of the plurality of respective forecasting models; and,
the determining which of the plurality of respective models provides the best forecasting result is based upon the ranking of the plurality of respective forecasting models.

18. The non-transitory, computer-readable storage medium of claim 13, wherein:
the forecasting intervals comprise respective forecasting seasons, the target forecasting interval comprise target forecasting seasons, the historical forecasting intervals comprise respective historical forecasting seasons; and,
a market behavior forecast is generated for each season using the particular machine learning operation.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
